(19) United States
(12) Patent Application Publication
(10) Pub. No.: US 2003/0111850 A1
(43) Pub. Date: Jun. 19, 2003

(54) Non-housing, grip-type door handle and processes for assembling same

(75) Inventor: Kyoung-Taek Kwak, Seoul (KR)

Correspondence Address: PENNIE & EDMONDS LLP, 3300 Hillview Avenue, Palo Alto, CA, 94304, US

(73) Assignee: Hyundai Motor Company

(21) Appl. No.: 10/356,302

(22) Filed: Jan. 31, 2003

Related U.S. Application Data
(62) Division of application No. 10/096,175, filed on Mar. 8, 2002.

(30) Foreign Application Priority Data
Jul. 12, 2001 (KR) 2001-42052

(51) Int. Cl. E05B 3/00

(52) U.S. Cl. 292/336.3

(57) ABSTRACT

A non-housing grip type door handle of a vehicle comprising a handle assembly integrating pad, door lock assembly, handle, hinge part and lever to be mounted onto an external panel of a door; and a base accommodated at the rear side of an external panel to mount the handle assembly, and it is manufactured according to the steps of: accommodating a handle assembly onto a mounting part of an external panel of a door; accommodating a base at the rear side of the mounting part; and fastening and coupling the base, external panel and handle assembly with a fastening unit from the rear side of the mounting part to the front side thereof.

### FIELD OF THE INVENTION

The present invention relates to a non-housing, grip-type handle mounted onto an external panel of a vehicle door, and more particularly to a non-housing, grip-type handle of a vehicle door having a base for increased strength and processes for assembling same to improve efficiency and utilize a conventional assembling line.

### BACKGROUND OF THE INVENTION

In general, a vehicle door handle is assembled onto an external panel of a door to open the door from outside of the vehicle, with double functions of being gripped and being unlocked through a relevant linking system. Furthermore, the handle is required to have strength to endure load necessary to unlock the door and excessive manipulations in practice and tenacity to allow for frequent uses. The handle is also an important element in designing internal and external appearance of the vehicle. On the other hand, a non-housing, grip-type handle is typically mounted on an external panel of a door without housing, currently being frequently applied to new samples of domestic and foreign auto vehicles due to a desirable appearance.

Processes for assembling a general non-housing, grip-type handle will be described with reference to FIGS. 1a through 1d. First of all, a pad 2 is inserted onto an open part 1b of a handle mounting part 1a of an external panel 1. A base 3 is mounted at the rear (opposite) side of the external panel 1 via the open part 1b (FIG. 1a). Then, base 3 is fixed with a bolt 4 at the panel 1, and one side of a wire is assembled to a latch of the base 3 and the other side to the handle 6 (FIG. 1b). Next, a door locking assembly 7 is inserted into the base 3 with the handle 6 open (FIG. 1c). Finally, a bolt is tightened to let a locking retainer 9 turn around to get the locking assembly 7 fixed at the base 3 (FIG. 1d).

However, the non-housing, grip-type handle thus constructed has a problem in that the assembly efficiency is low in existing assembling lines in comparison with that of a general housing integrated-type handle because it requires a greater number of operational steps and a greater amount of operational time.

The greater number of operational steps results from the base mounting process. There are cases where the base mounting process has been omitted to solve the aforementioned problem. However, it may be required to mount a base for satisfactory impact resistance. Therefore, there is still a problem of reducing the number of operational steps relating to the base mounting process.

### SUMMARY OF THE INVENTION

The present invention provides a non-housing, grip-type door handle for a vehicle to address impact resistance and processes for assembling the non-housing, grip-type door handle to reduce the number of operational steps in addition to utilizing the conventional assembling line. Thus, according to the present invention, there is provided a non-housing, grip-type door handle for a vehicle, which includes a handle assembly integrating pad, door lock assembly, handle, hinge part and lever to be mounted onto an external panel of a door. Further, a base is accommodated at the rear side of the external panel to mount the handle assembly.

In addition, there is also provided processes for assembling the non-housing, grip-type door handle of a vehicle, According to a preferred embodiment of the invention, the handle is assembled by accommodating a handle assembly in a mounting part of an external panel of a door, accommodating a base at the rear side of the mounting part, and fastening and coupling the base, external panel and handle assembly with fastening means from the rear side of the mounting part to the front side thereof.

According to an alternative preferred embodiment, the present invention includes a door handle assembly and base adapted to be mounted on an external panel of a vehicle door, the panel having an outside and an inside. The handle assembly includes a door lock assembly cooperating with a lever, a hinge part and a handle grip portion between said hinge part and lock assembly, said handle assembly configured to be mounted on the out side of the door panel and cooperating together to for a functioning handle mechanism. The base is mounted on the inside of the external door panel to secure said handle assembly in place. Preferably, the handle assembly and base are configured and dimensioned to cooperate with an external door panel having a concave recess adapted to accommodate a user's hand when placed around the handle grip portion. The handle assembly may also further include a pad disposed to contact said external panel around the lever and hinge part.

In a further aspect of the invention, the hinge part and lever of the handle assembly are configured to be mounted through the external door panel. Accordingly, the base defines first, second and third openings, the first opening being adapted to receive therethrough the hinge part, the second opening being adapted to receive therethrough the lever. The third opening is adapted to receive the protrusion of the inside of the panel wall that results from the formation of the concave recess on the outside of the panel. Preferably, the base is made up of at least first and second portions separated by a third portion, the first and second portions defining surfaces that at least approximately lie in parallel planes. The third portion further defines a surface at least substantially matching a portion of the protrusion on the inside of said door panel resulting from the recess.

In a further alternative embodiment, method for assembling a door handle onto an external panel of a vehicle door is also provided by the present invention. According to this embodiment, a handle is provided assembly including door lock assembly cooperating with a lever, a hinge part and a handle grip portion between said hinge part and lock assembly, the handle assembly is mounted on the outside of said external door panel, the base is placed on the inside of the door panel in alignment with said handle assembly, and the handle assembly and base are fastened together on the door panel. Preferably the mounting comprises inserting the lever through a cooperating opening in the door panel and inserting the hinge part through another cooperating opening in the door panel. Additionally, a first opening of the base is placed over the hinge part and a second opening of the base is placed over the lever.

### BRIEF DESCRIPTION OF THE DRAWINGS

Objects and aspects of the invention will become apparent from the following description of preferred embodiments with reference to the accompanying drawings in which:

FIGS. 1a through 1d illustrate assembling processes for a non-housing, grip-type door handle of a vehicle in accordance with the prior art;

FIGS. 2a and 2b illustrate a structure for a non-housing, grip-type door handle of a vehicle and processes for assembling the same in accordance with the present invention; and

FIG. 3 illustrates a completely assembled non-housing, grip-type door handle according to the invention as seen from the front and rear of an external panel of a vehicle door.

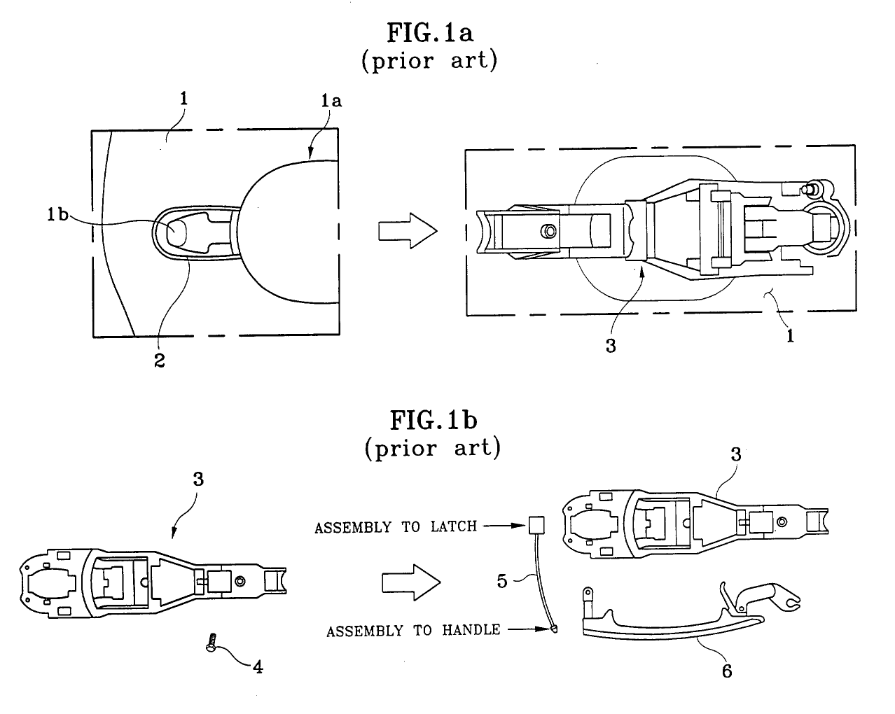

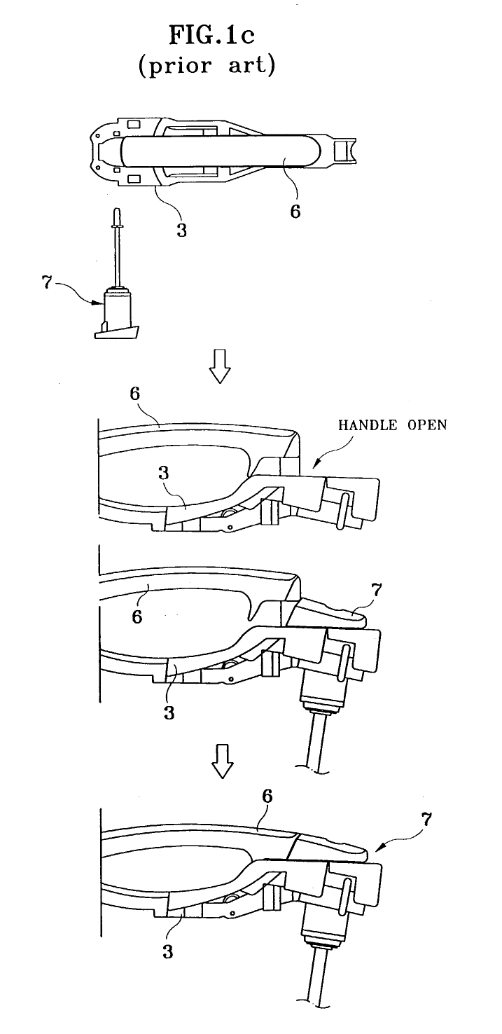

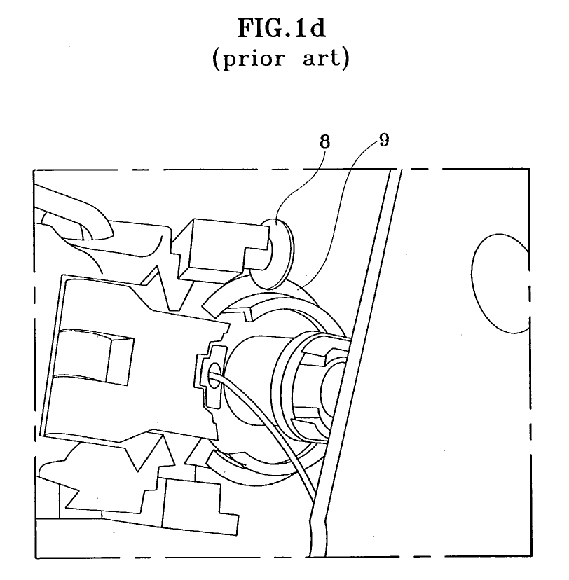

### DETAILED DESCRIPTION OF THE INVENTION

Hereinafter, preferred embodiments of the present invention will be described in detail with reference to accompanying drawings.

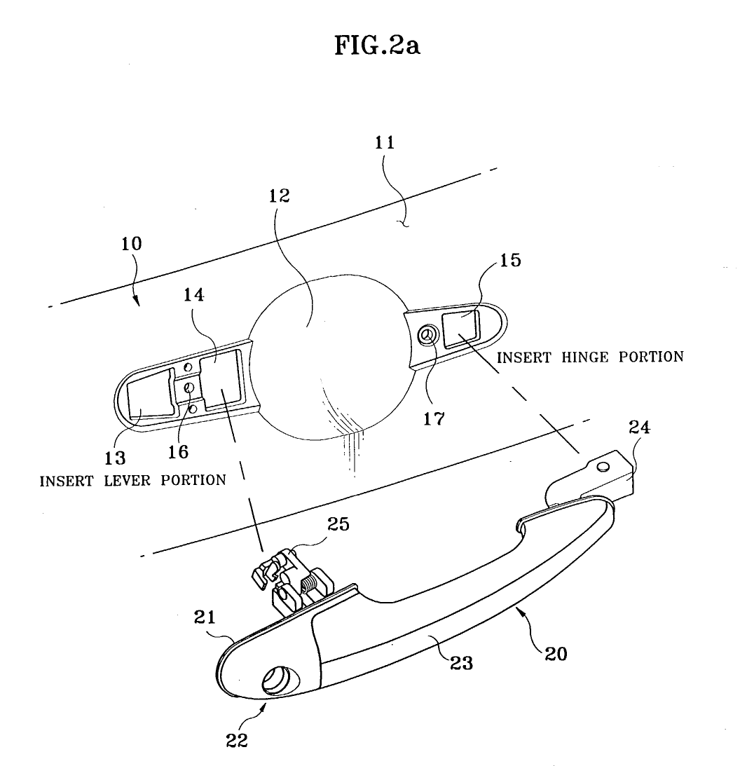

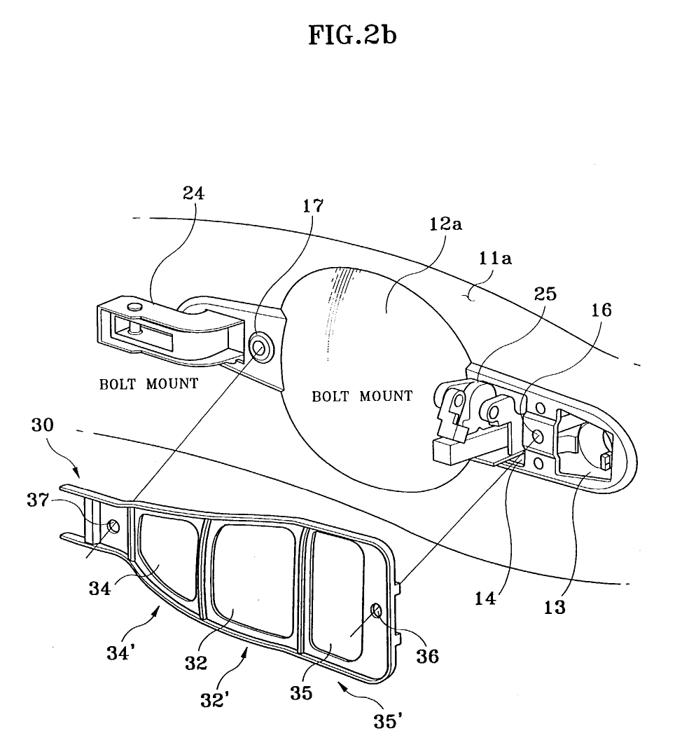

As shown in FIG. 2a, a mounting part 11 is formed at an external panel 10 of the vehicle door for accommodation of a handle assembly 20. The mounting part 11 includes a concave part 12 (concave in to the page as shown in FIG. 2a) formed in a semicircular shape for convenient insertion of a hand and three openings 13, 14, 15 and two bolt holes 16, 17. Handle assembly 20 is preferably formed as an integral unit having a pad 21, door locking assembly 22, handle grip portion 23, a hinge part 24 and a lever 25. The handle assembly 20 is attached to mounting part 11 by placing the locking assembly 22 in opening 13 via the bottom frame of the pad 21, inserting the lever 25 into opening 14 and inserting the hinge part 24 into opening 15.

FIG. 2b illustrates the back side 11a of mounting part 11 of the external panel 10 where handle assembly 20 is mounted. There is a rear part 12a of the concave part 12 that is protruded in a semicircular shape (i.e., convex on this side), lever 25 and hinge part 24 inserted inwardly through openings 14 and 15 respectively.

Base 30, with bolt holes 36, 37 facing bolt holes 16, 17, has an opening 34 for insertion of hinge part 24, another opening 35 for insertion of lever 25 and a further opening 32 protruded in a semicircular shape, for accommodation of rear part 12a of the concave part 12. Portions 34′, 35′ of base 30 where the open parts 34, 35 are formed are preferably parallel with the portions of base 30 that face rear side 11a. Portion 32′ of base 30 where the open part 32 is formed has a predetermined level of a curve according to a shape of the rear part 12a.

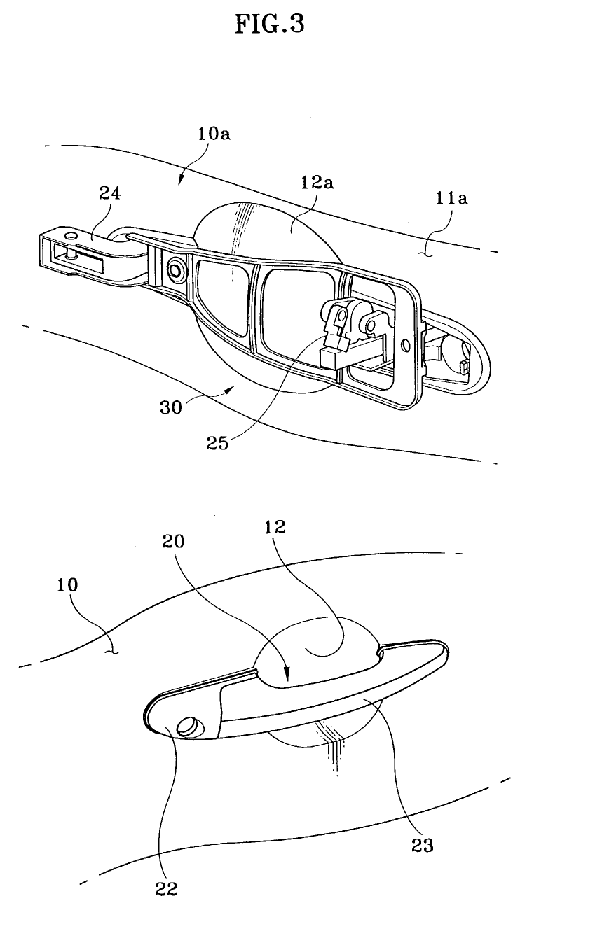

As a result, the panel containing mounting part 11 will have a greater resistance to impact on the front side of the external panel, and the panel is less likelys to be dented inwardly owing to a buffering function of the base that supports at the rear side 11a. With base 30 accommodated at the rear side 11 a of the mounting part 11, bolts are inserted through the bolt holes 36, 37, 16, 17 from the rear side 10a of the external panel 10 to outside for fixation of the handle assembly 20 at the external panel 10 (FIG. 3).

As described above, the present invention provides advantages in addressing impact resistance and, at the same time, of providing a reduction in the number of operational steps at the conventional operational line.

What is claimed is:

1. A door handle adapted to be mounted on an external panel of a vehicle door, the panel having an outside and an inside, said handle comprising:
a handle assembly, including a door lock assembly cooperating with a lever, a hinge part and a handle grip portion between said hinge part and lock assembly, said handle assembly configured to be mounted on the out side of the door panel and cooperating together to for a functioning handle mechanism; and
a base mounted on the inside of the external door panel to secure said handle assembly in place.

2. The handle, as defined in claim 1, wherein the handle assembly further comprises a pad disposed to contact said external panel around the lever and hinge part.

3. The handle, as defined in claim 1, wherein the handle assembly and base are configured and dimensioned to cooperate with an external door panel having a concave recess adapted to accommodate a user's hand when placed around the handle grip portion.

4. The handle, as defined in claim 3, wherein the hinge part and lever of the handle assembly are configured to be mounted through the external door panel and wherein the base defines first, second and third openings, the first opening being adapted to receive therethrough said hinge part, the second opening being adapted to receive therethrough said lever, and the third opening being adapted to receive said concave recess.

5. The handle, as defined in claim 4, wherein said base comprises first and second portions separated by a third portion, said first and second portion defining surfaces that at least approximately lie in parallel planes and said third portion defines a surface at least substantially matching a portion of said recess on the inside of said door panel.

6. A method for assembling a door handle onto an external panel of a vehicle door, the panel having an inside and an outside, said method comprising
providing a handle assembly including door lock assembly cooperating with a lever, a hinge part and a handle grip portion between said hinge part and lock assembly;
mounting said handle assembly on the outside of said external door panel;
placing a base on the inside of the door panel in alignment with said handle assembly; and
fastening the handle assembly and base together on said door panel.

7. The method, as defined in claim 6, where said mounting comprises inserting the lever through a cooperating opening in the door panel and inserting said hinge part through another cooperating opening in the door panel.

8. The method, as defined in claim 7, wherein said base has at least first and second opening and said placing comprises placing the first opening of the base over the hinge part and placing the second opening of the base over the lever.
